(19) United States
(12) Patent Application Publication
(10) Pub. No.: US 2016/0374180 A1
(43) Pub. Date: Dec. 22, 2016

(54) LED LAMP STRIP, METHOD AND SYSTEM FOR CONTROLLING THEREOF

(71) Applicant: Document Solutions International, Inc., Tamarac, FL (US)

(72) Inventor: Xu FENG, Tamarac, FL (US)

(73) Assignee: Document Solutions International, Inc., Tamarac, FL (US)

(21) Appl. No.: 15/180,712

(22) Filed: Jun. 13, 2016

(30) Foreign Application Priority Data
Jun. 13, 2015 (CN) 2015-20405339

(51) Int. Cl. H05B 37/02; F21S 4/24; F21V 23/00; H05B 33/08; F21S 4/28; F21V 23/06

(52) U.S. Cl. CPC H05B 37/0227; H05B 37/0272; F21S 4/28; F21V 23/06; F21V 23/008; H05B 33/0845; H05B 37/0281; H05B 33/0863; H05B 33/0854; F21S 4/24; F21Y 2115/10

(57) ABSTRACT

The invention discloses a light emitting device capable of being controlled by a remotely located mobile phone, and a method and a system for controlling the light emitting device. The light emitting device comprises a light strip and a control panel, wherein the light strip includes a printed circuit board, lamp beads, and a butt terminal, and wherein the control panel comprises a remote connection module and a control module. The method for controlling the light emitting device may include detecting vibrations in the environment, determining whether to transmit signals based on the detected vibrations, determining whether to trigger changes in the lamp bead operation, based on signals received from a the remote communication device and/or from the sensor module.

### RELATED APPLICATIONS

This application claims the benefit priority of foreign Chinese Application Serial No. 2015-20405339, filed Jun. 13, 2015, published on Nov. 4, 2015, and granted on the same date as CN204739460U.

### BACKGROUND OF THE INVENTION

The present invention generally relates to the field of light emitting technology, and to a method and a system for remotely controlling a light emitting device through a mobile phone. More particularly, the present invention relates to a light strip and a control panel for receiving signals from a mobile phone, via, for example, a Bluetooth connection.

Traditionally, light emitting devices are controlled using either a wire or an infrared remote control for transmitting signals to light emitting devices. The infrared remote control must be configured before use, must be a significantly close to the light emitting device for transmitting the signals, and must be aligned in the direction of the infrared receiver. Furthermore, it is necessary to find the correct matching remote control, which can be difficult if numerous controlled light sources are in the same facility.

Additionally, traditional light emitting device controllers do not support rich features and/or functionalities.

### BRIEF SUMMARY OF THE INVENTION

One or more of the embodiments of the present invention provides for a convenient manner to control a light strip by allowing the user to directly control the switching and rythm of the light strip through a mobile phone. This allow the user to control the light strip at any time of the day and from any place in which a connection can be established between the mobile phone and the light source which can be an LED light strip. Additionally, by utilizing LED lights, one or more embodiments of this invention provide for reduced manufacturing costs, longer life span, low power consumption, among other advantages. Additionally, LED lights comply with environmental protection requirements.

Additionally, one or more embodiments of the present invention include several different features for means, ways, and manners for controlling, lighting, and switching the light emitting device.

Another embodiment of the invention provides a remote control via mobile phone of a Bluetooth LED light strip. The LED light strip may be controlled using a wireless Bluetooth mode or any other wireless connection that allows the user to control the light emitting device without direction limit or without the need for an additional dedicated remote control.

The light emitting device may comprise a light strip and a control panel. The light strip may include a printed circuit board, a lamp bead capable of emitting light wherein a number of lamp beads are spaced along the printed circuit board, and a butt terminal installed in the extremity of the printed circuit board and capable of being attached to, and/or capable of being detached from other connectors and/or another butt terminal. The control panel may comprise a remote connection module capable of establishing a connection between the light emitting device and a remote communication device for transmitting signals, and a control module capable of receiving signals, wherein the remote control module is capable of triggering changes in the lamp beads operation based on the signals received.

The method for controlling a light emitting device may comprise determining whether to establish connection between a light emitting device and a remote communication device, detecting vibrations in the environment, determining whether to transmit signals based on the detected vibrations, determining whether to trigger changes in the lamp bead operation, based on signals received from a the remote communication device and/or from the sensor module.

The system for concerted light emission may comprise a remote communication device, a light emitting device capable of connecting to and receiving signals from the remote communication device, wherein the light emitting device may comprise a lamp bead capable of emitting light, and a control panel capable of changing the light emitting device behavior, wherein the control panel comprises a remote connection module capable of establishing a connection between the light emitting device and the remote communication device a sensor module, and wherein the sensor is capable of detecting vibrations in the environment, and a remote control module capable of receiving signals from the remote communication device.

### BRIEF DESCRIPTION OF THE DRAWINGS

FIG. 1 is a perspective view of the LED strip and controller of an exemplary embodiment of the present invention.

FIG. 2 is schematic structural assembly diagram of the light emitting device and controller box, according to one embodiment;

FIG. 3 through 6 are circuit board layout diagrams of the of board layers of the light emitting device controller, according to one embodiment;

FIG. 7 is a circuit diagram illustrating an embodiment of the controller of the present invention;

FIG. 8 is an illustration of a user interface for controlling the light emitting device, according to one embodiment.

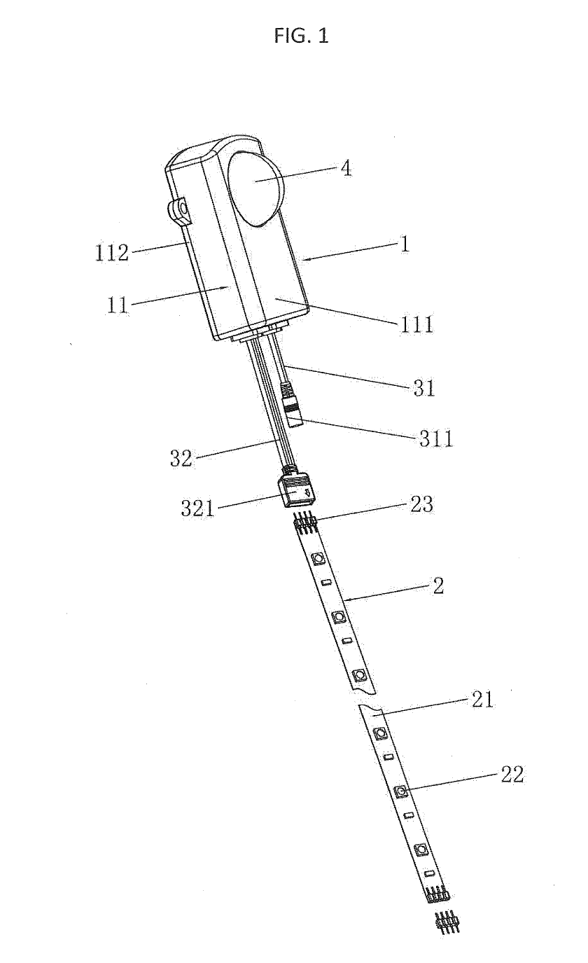

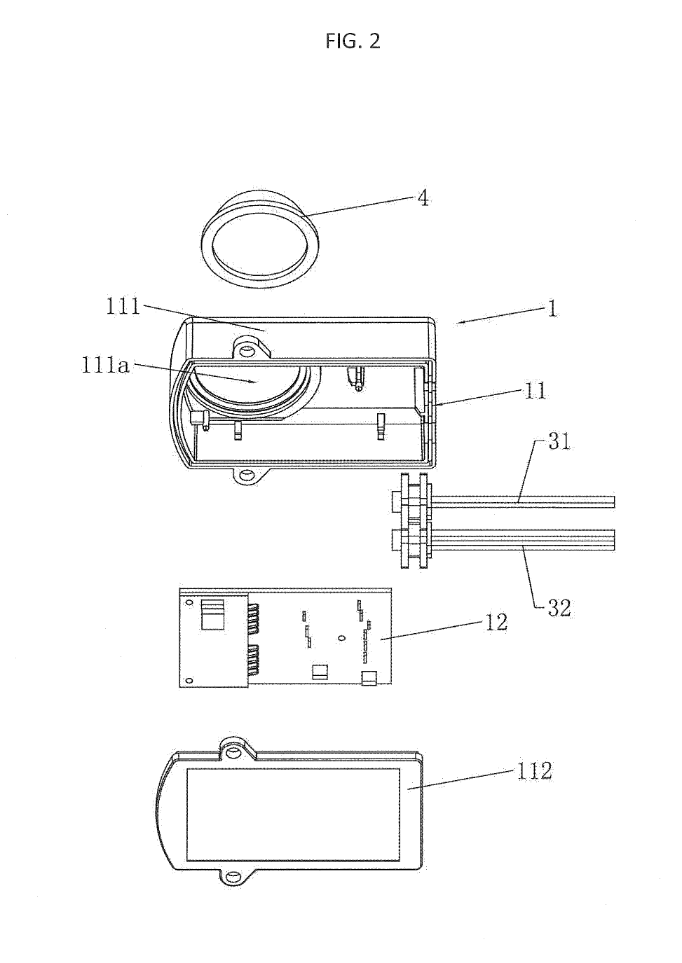

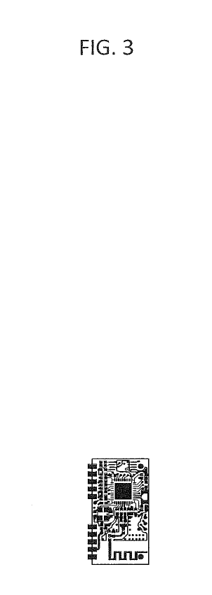

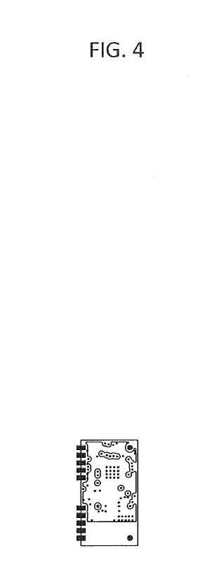

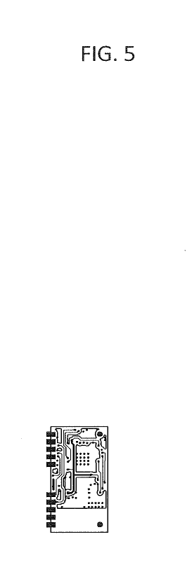

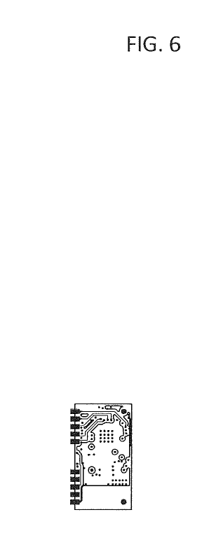

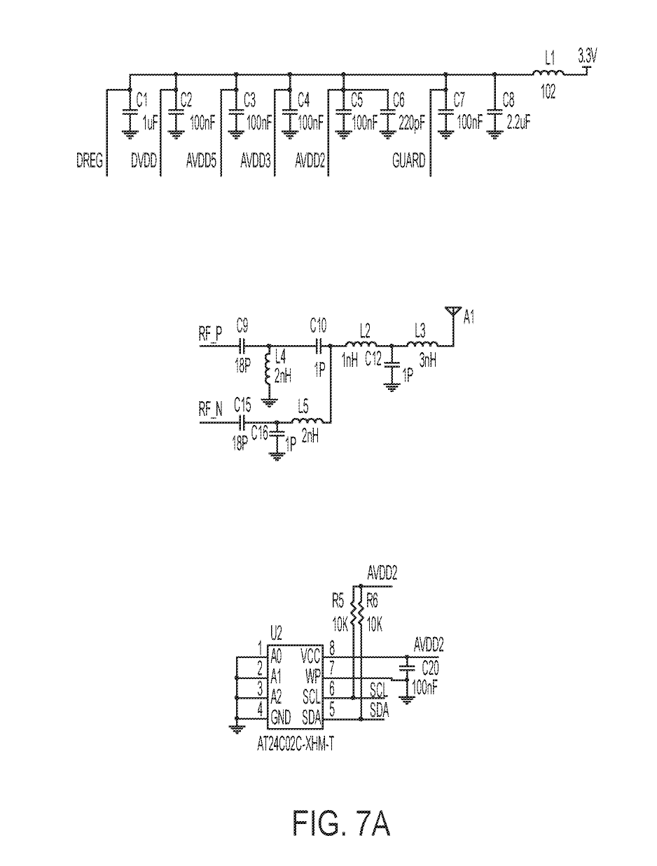

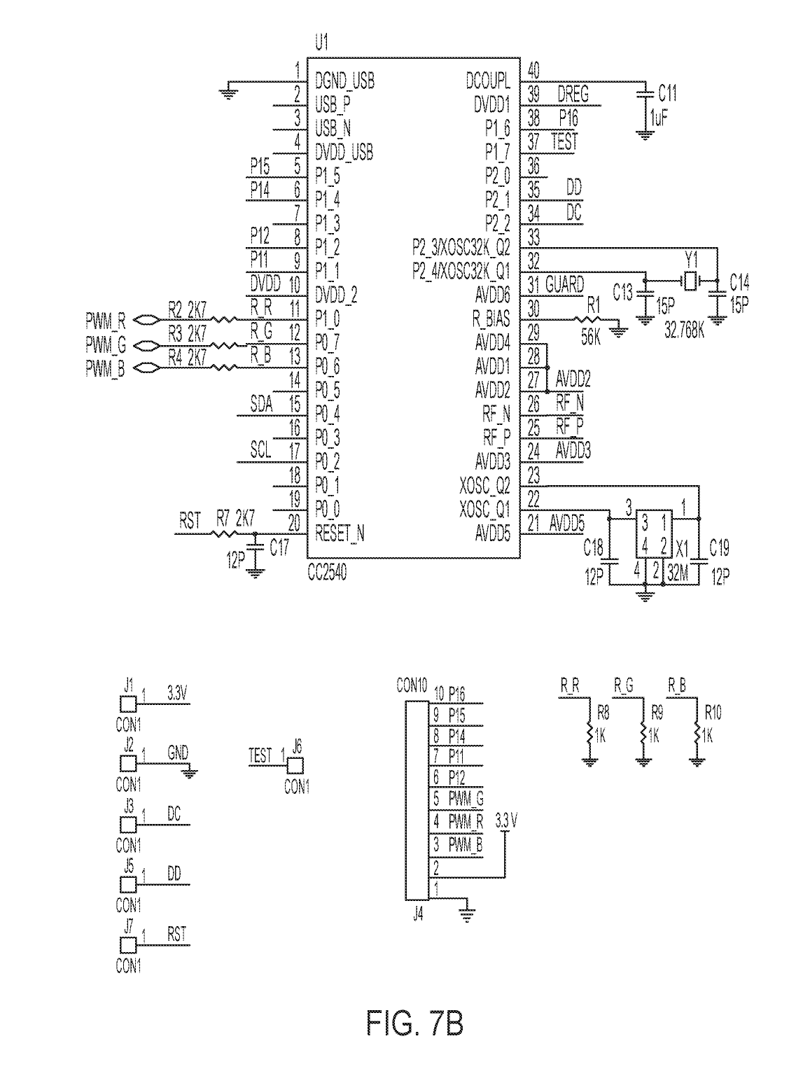

### DETAILED DESCRIPTION

The following detailed description of the invention is merely illustrative in nature and is not intended to limit the embodiments of the subject matter or the application and uses of such embodiments. As used herein, the word “exemplary” means “serving as an example, instance or illustration.” Any implementation described herein as exemplary is not necessarily to be construed as preferred or advantageous over other implementations. Furthermore, there is no intention to be bound by any expressed or implied theory presented in the sections of this specification.

The light emitting device includes a controller 1 and light bar of LED's 2. The Light bar of LED's 2 includes substrate 21, which might be a printed circuit board or another material, and lamp beads LED 22 which may be evenly spaced along the substrate 21 of the PCB.

The controller 1 may include a control housing 11 which may have a cover 111 and base of controller 112, which might be secured to each other by a screw or using any other means for securing the cover 111 to the base 112. Inside the control housing there might be a cavity at the cover 111 for accommodating the control panel 12.

The control panel 12 may be installed inside the controller 1 inside the control housing and the base of controller 112. Input line 31 and output line 32 may also be partially inside the control housing 11 and extending to the lateral of control housing 11 and may be connected to control panel 12. The input terminal 311 may be at the distal end of the input line 31 for connecting the device with an external power supply. Output terminal 321 may be at the distal end of output line 32. Butt terminal 23 may be installed at the substrate 21 for allowing mating with the output terminal 321.

A Bluetooth module may be assembled in the control panel 12, or may be electrically connected to the panel 12.

The light emitting device may be remotely controlled by a mobile phone, a tablet, aq computer or other device having bluetooth capabilities, which may be connected through bluetooth or any other type of remote connection traditionally found on a cell phone. An LED status indicator can be included in the control panel (12) to indicate the status of the controller. The cover 111 may include an opening 111a for viewing the indicator light and a translucent window 4 to allow for observation.

The substrate 21 may be a PCB hard board, a flexible PCB, or another board with various levels of flexibity, including a kind of soft circuit board.

The light emitting device, in accordance with embodiments of the invention, allows for a user to remotely control the light emitting device through his/her mobile device, which may use a bluetooth connection. The device provides for a more flexible means for controlling the light emitting device, as opposed to the traditional infrared remote control device. This allows the user to control the device at any direction, i.e. without having to point to a specific direction. Additionally, the user may configure the on/off timing pattern at any time using its mobile phone, which can be done in various manners, beats, tunes, or utilizing various features for execution of the light switch.

The user may utilize an application, for example a smart phone application, for executing and controlling the light color, light switch, light synchronization, such as light synchronization with external events such as sound beats.

Once the connection is established between a user mobile phone and the light emitting device, the user may control the light switch or allow the control panel 12 to control the light switch, or both. At first, the user can send control signal to the bluetooth module in the control panel through bluetooth module in the mobile phone. Then the control panel (12) may receive the signal from the mobile and commence controlling the working state of lamp beads 22 of the light bar 2. Users can adjust the time switch at any time through the phone without extra controller. The user may also give up some or all of the control of the switching of the light beads so as to allow the user to interfere in the rythm of the switching or flashing of the light beads.

Once connection between the user mobile device and the light emitting device is established, the light bar 2 may, for example, glow or light up when the user plays music or when the device receives a phone call or when an alarm is triggred. The light bar may flash to the sound in a rhythmic way. The sound may be sourced in the user's mobile phone or in the environment, in which case, the control panel 12 may sense the vibration of sounds waves and transmit a signal to the light bar 2 for the light beads to glow or light up in a rhythmic manner.

The input line 31 may connect to the outside power supply through input terminal 311. Output line 32 may connect to butt terminals 23 of light bar 2 through output terminals 321. The structure design can realize quick and easy disassembling and assembling. This allows the user to have a light bar 2 virtually at any size the user desires.

In another embodiment of this invention, the indicator of LED behind window 4, prompts the working state of controller 1.

In accordance with one embodiment, once the appropriate APP control program is installed on the user's phone, the control board 12's Bluetooth module is synced with the phone's Bluetooth module to achieve matching docking. The user can send control signals to the control board Bluetooth module 12 through the phone's Bluetooth module. The control board receives the control signal transmitted by the handset and controls the LED light bar 2, work status LED 4, lamp beads 22, users do not need an additional special remote control to control the LED light bar 2, and can be realized through the mobile phone LED light strip 2, 24 hours timer switch at any time.

When the user's mobile phone plays music, the LED light bar 2 may be activated by the music rhythm flashing light. Additionally, the light may be flashing depending on the ambient sound environment, which can be a rhythmic flashing, or based upon a phone call, a callers voice, an alarm or other event programable into t the phone, independent of any need to reprogram the light controller 1.

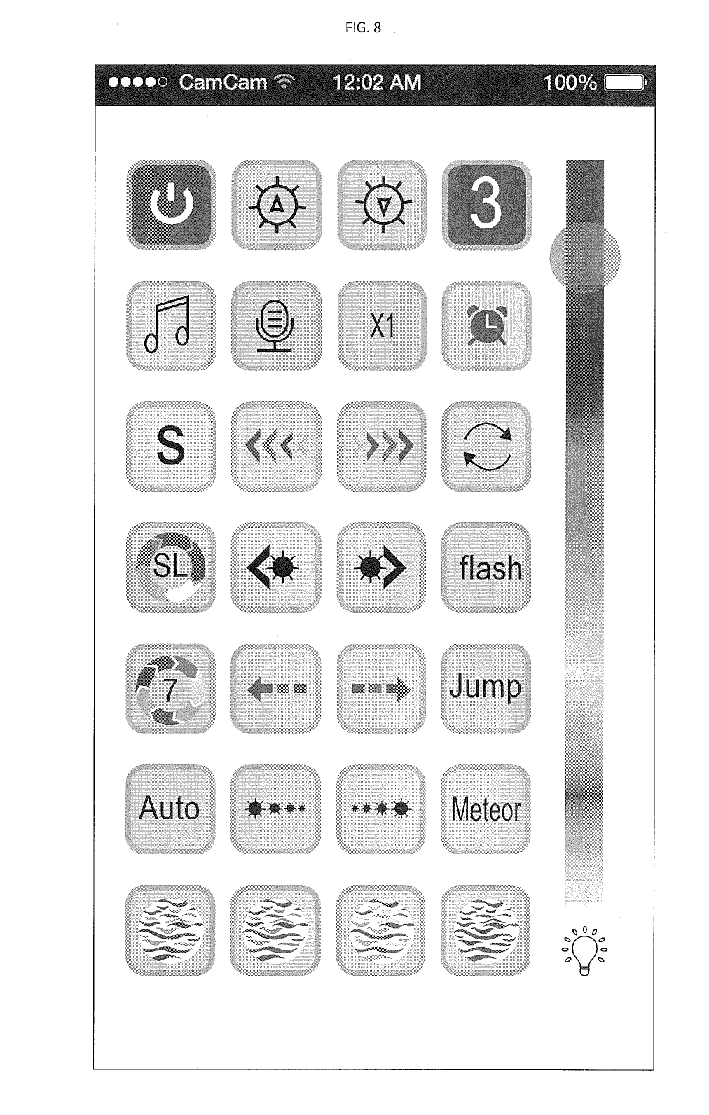

FIG. 8 is an illustration of a user interface for controlling the light emitting device, according to one embodiment. The main user interface may include several buttons for allowing the user to perform several different tasks. The main interface may include buttons/links to other user interface or screens that allow the user to perform further tasks. It is also contemplated that the buttons/options may be distributed through the user interface in several different manners and forming different combinations. These buttons/options may also be used for other features upon selection of a third button that changes the functionality of the

In one embodiment, the user interface may include an option for turning the light emitting device on and off. This button may also be used to close the phone application or minimize it, or to turn a specific light beads on or off without having to turn all the light beads.

In another embodiment, the user interface may also include at least one button/option to allow the user to adjust the brightness of the light beads for allowing the users to perform more complex flashing, rhythms or patterns.

In yet another embodiment, the user interface may include a number which might correspond to a light bead, section of the strip, or umber of light beads or sections of the strip. This allows the user to change the lighting, flashing or pattern of a specific bead or section.

An embodiment of the invention may a spectrum of colors so as to allow the user to adjust the colors of the light. The option to change colors may also be represented by one or more buttons/options in the user interface. In case there is only one button for colors, the user may keep pressing the single button and the color of the button may also change, which represents the color of the light being emitted.

In one embodiment, the user interface includes buttons for changing the song being played or to take the user to a different interface screen so the user can choose a sing to be played. The songs being played might be in any manner synchronized to the flashing or pattern of the switching of the light. An embodiment may also include a voice option, which depending on the pitch may change the patterns or flashing of the light bead.

In one embodiment, the user interface may also include a speed button options for changing the speed of the flashing or pattern of the light. The user interface may include at least three speed patterns and the user may be able to change the speed by simply selecting the button so as to make it faster or slower.

In yet another embodiment, the user interface may include a timer for stopping, initiating, or changing patterns or flashing of the light beads. The timer may also be used for stop, initiating or changing the color of light or its brightness.

In one embodiment, the user interface may include a button option to initiate or stop a given saved pattern/flashing or any pattern previously performed. The previously performed patterns/flashing may also be changed upon selection by the user of another button/option with such functionality.

In one embodiment, the user interface includes a button for repeating a pattern, song, brightness, color or any previously used feature. The previously used feature may be a feature not immediately previously used. That is, the repeating button/option may allow the user to repeat a pattern used, for example, twelve hours ago.

In yet another embodiment, the user interface may include an auto initiator for the patterns or flashing, and another button/option may be included for specific pre-defined pattern, such as meteor pattern, or a jump pattern. The jump or meteor patterns may also be based on the vibration of the environment. The jump or meteor patterns/flashing may also be a modifier of other patterns/flashing.

In one embodiment, the user interface may include buttons/options for combining several different patterns and to create other patterns based on these combinations or modifications.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

We claim:

1. A light emitting device comprising:
a light strip comprising:
a printed circuit board;
at least one lamp bead capable of emitting light wherein a plurality of lamp beads are spaced along the printed circuit board; and
a butt terminal installed in the extremity of the printed circuit board and capable of being attached to, and/or capable of being detached from other connectors and/or another butt terminal;
a control panel comprising:
a remote connection module capable of establishing a connection between the light emitting device and a remote communication device for transmitting and/or receiving signals; and
a control module capable of receiving signals, wherein the remote control module is capable of triggering changes in the operation of the lamp beads based on the signals received.

2. An apparatus of claim 1, wherein the printed circuit board is flexible.

3. An apparatus of claim 1, wherein the control module is capable of detecting patterns in the signals received, and of triggering changes in the lamp beads' operation based on the detected patterns.

4. An apparatus of claim 1, wherein the remote connection module is capable of establishing a bluetooth connection between a remote communication device and the light emitting device.

5. An apparatus of claim 1 further comprising a sensor module capable of detecting vibrations in the environment, and of transmitting signals based on the detected vibrations.

6. An apparatus of claim 5, wherein the control module is capable of triggering changes in the lamp bead operation based on a combination of one or more remote communication device signals and of one or more sensor module signals.

7. An apparatus of claim 1, wherein the control module is capable of detecting patterns in the signals received, and of triggering changes in the lamp bead operation based on the detected patterns.

8. An apparatus of claim 1, wherein the remote communication device is a mobile device.

9. A method for controlling a light emitting device comprising:
determine whether to establish connection between a light emitting device and a remote communication device;
detecting vibrations in the environment;
determining whether to transmit signals based on the detected vibrations;
determining whether to trigger changes in the lamp bead operation, based on signals received from a the remote communication device and/or from the sensor module.

10. A system for concerted light emission comprising:
a remote communication device;
a light emitting device capable of connecting to and receiving signals from the remote communication device, wherein the light emitting device comprises:
a lamp bead capable of emitting light; and
a control panel capable of changing the light emitting device behavior, wherein the control panel comprises:
a remote connection module capable of establishing a connection between the light emitting device and the remote communication device;
a sensor module, wherein the sensor is capable of detecting vibrations in the environment;
a remote control module capable of receiving signals from the remote communication device.
